(19) United States
(12) Patent Application Publication
(10) Pub. No.: US 2006/0144851 A1
(43) Pub. Date: Jul. 6, 2006

(54) Multipurpose Dispenser

(76) Inventor: Victor Gonzalez De Echavarri, Bilbao (ES)

Correspondence Address: RATNERPRESTIA, P O BOX 980, VALLEY FORGE, PA, 19482-0980, US

(21) Appl. No.: 10/527,657

(22) PCT Filed: Sep. 11, 2003
(86) PCT No.: PCT/ES03/00460

§ 371 Date: Dec. 28, 2005

(30) Foreign Application Priority Data
Sep. 13, 2002 (ES) P200202100

(51) Int. Cl. B67D 5/08; B67D 5/14

(52) U.S. Cl. 222/52

(57) ABSTRACT

A multipurpose dispenser is provided. The multipurpose dispenser comprises two deposits and having different products and means for dispensing each of them simultaneously or alternatively. A control plate controls two motors. The first motor transmits its movement via gears to a pusher element which acts on a push-button arranged at the exit to the valve of deposit, dispensing the contents of the deposit either in a dropwise manner to channels or pipes, or by spraying it outside through a window created for this purpose in the dispenser cover, and the second motor drives a fan that circulates air containing the product held in deposit that is evaporated by a cord, the air exiting to the outside via gratings according to the rotation direction of the fan.

This application is a U.S. National Phase Application of PCT International Application No. PCT/ES2003/000460 filed Sep. 11, 2003.

### FIELD OF THE INVENTION

This invention relates to a new multipurpose dispenser, as indicated in the name and title of this specification, which has various functions and is not limited to dispensing pressurised or sprayed liquids, but which, at the same time or alternatively or simultaneously, according to its programming and requirements, can dispense room fresheners, insecticides, etc., by vaporisation, directly into the atmosphere. The multipurpose dispenser combines all these functions whereby it provides considerably important and advantageous characteristics with respect to the dispensing apparatuses and devices that are currently known for fulfilling similar purposes.

### BACKGROUND OF THE INVENTION

Known dispensers do not have all the functions and possibilities described in association with this multipurpose dispenser. As an example, Spanish Patent No. 9701087 and Spanish Utility Model No. 200101481 are known, which are merely liquid dispensing apparatuses. Also, Spanish Utility Model No. 99002960 is known which is only a room freshener device. The apparatuses in these documents are included among many others that are known conventionally in the market, all of them having limited possibilities, whereby they must be replaced depending on the intended purposes and the places where they are going to be installed. Contrary to this, the new multipurpose dispensing apparatus according to this invention can be used practically everywhere, and for practically all the currently known uses of bacteriostatics and room fresheners, and even insecticides.

In short, it is a combination of different elements in one and the same dispenser, which comprises two deposits holding different contents that can be used in combination, alternatively or totally independently, and which are controlled automatically by one single control that can be programmed according to the functions to be fulfilled. This combination and arrangement represents a great development in the state of the art, since a device having these characteristics is not known in the market, only those devices that are generally independent having one of the individual functions, not combined with the others.

### SUMMARY OF THE INVENTION

According to one aspect, the multipurpose dispenser of the present invention comprises a pressurising or spraying system which is controlled automatically to supply the product directly to the relevant channels, or into the atmosphere, and its purpose is to permit the cleaning, deodorisation, and the disinfection, sanitation or disinsectisation of sanitary equipment in the bathroom, toilet, public lavatory, etc, and also of the environments themselves, both public and private. This is achieved thanks to its automatic control, which enables the dispenser to operate according to the requirements and purpose of each place where it is installed, but which, in turn, offers the possibility of replacing the dropwise system directed at conduit channels, with a direct spraying action into the atmosphere.

Moreover, it comprises another system inside the same apparatus which, being controlled in the same automatic fashion but with a separate motor, is intended to direct an essence that can be either a deodorant, a room freshener or even an insecticide, directly into the atmosphere in the place where the apparatus is installed, which will mainly be a bathroom, as indicated above, but which can be any other place having other greater needs for refreshing, disinfecting or disinsecting the atmosphere.

All this is achieved with one single apparatus having the whole ensemble combined and automatically controlled, allowing said multiple functions to which the title of the invention refers, to exist either separately or in combination, and this consequently affords important advantages, both in terms of the manufacture and/or assembly, and the use of the actual dispensing apparatus.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1—This is the main drawing and it represents a front view of the dispenser, without the front cover 5, in which the arrangement of all the main dispenser elements can be observed, beginning with the position in the central-right hand lower part thereof of the main deposit 7, which includes the valve 20 and the push-button 19. In the lower left hand part there is the smaller essence deposit 10, incorporating the cord 11. In the top left hand part, there appears the fan 13 which circulates the air treated with the product contents that is evaporated by the cord 11, and in turn the gears 16 and 17 which are driven by the motor 15, transmit the movement to the pusher element 18, which acts directly on push-button 19 of deposit 7. In the central right hand top part one can see where the dispenser control card or plate 21 is installed and to the right where the batteries 22 are located that power the control plate 21 and motors 15 and 14.

FIG. 2—Represents the dispenser cover and the arrangement of the ventilation gratings 24, 25, and 26 that are placed at three different heights, and through which the air where the dispenser is installed will enter and then exit treated with the product that is evaporated by the cord 11. The air current will be generated mainly by the action of the fan 13 and the rotation direction given to the fan as required, which activates one or other of the dispenser gratings as an air inlet or outlet.

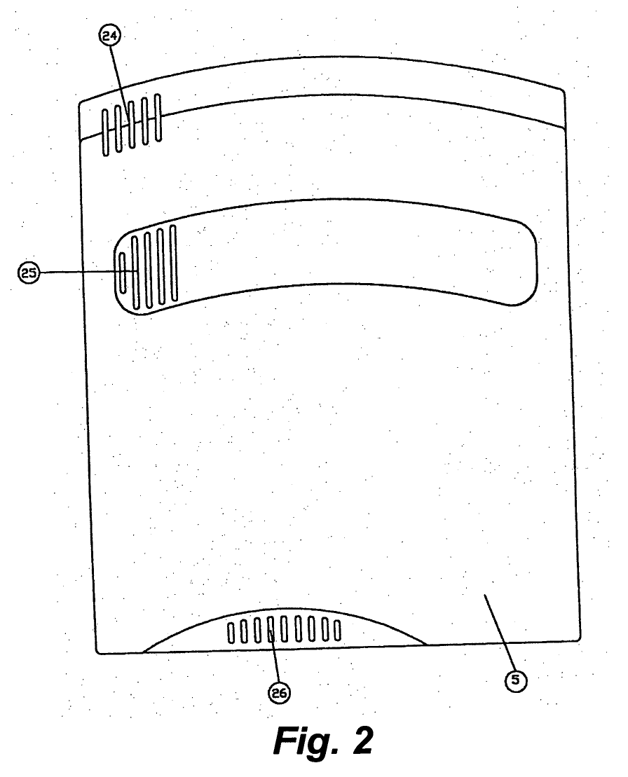

FIG. 3—Represents the dispenser cover seen from above so as to reveal its front curved shape 23 whereby it can conceal all the dispenser devices, occupying as small a space as possible.

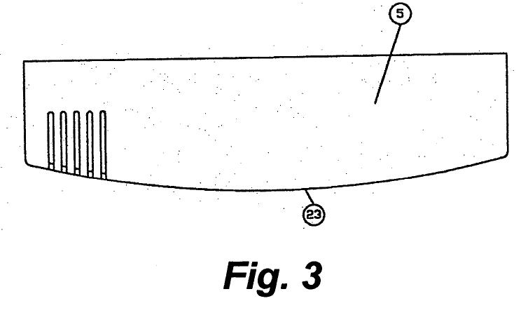

FIG. 4—Represents an alternative cover that would be used in combination with the push-button 19 that can be used alternatively so that instead of directing the drops to certain channels or pipes, it could spray them directly into the atmosphere, in which case the dispenser cover would incorporate the window 27.

### DETAILED DESCRIPTION OF THE INVENTION

Generally speaking, the multipurpose dispenser which is the subject-matter of this invention is intended to be able to dispense as much as may be required in order to obtain clean, disinfected, refreshed and sanitised places, by being able to avail of one or several of the functions as required each time, all this being possible by virtue of the combined dispensing of the essences and chemical liquids or products that already exist and are known in the market, mainly for bathrooms and toilets.

All this is achieved by providing a compact dispensing apparatus, having a unified, safe image owing to its restricted access in the form of a corresponding lock. The multipurpose dispenser provides some clear advantages, both in terms of its use, which we must remember will mainly be in bathrooms and public toilets, and in terms of its assembly, which is very simple owing to the fact that the dispenser is mounted on a base or frame which has a space prepared for installing each component element, and a front closing cover which in turn incorporates corresponding gratings for letting air or the dispensed product in and out. In turn, said cover makes it very easy to replace the deposits and batteries, without altering the operation of the apparatus in any way.

Therefore, referring to the appended figures, the dispenser according to the invention can be described by its different parts, comprising a frame 1 which incorporates the device's component elements. The frame is already prepared to be installed preferably on the wall, by being screwed on at points 2, and it has a quadrangular shape being longer than wider, with its top face 3 arching outwards. In the lower part thereof it has an arrangement 4 for laterally housing the hinges for the front cover 5, which, once installed, will close off the dispenser by means of a corresponding safety lock indicated at 6.

In the central and right hand lower part thereof, the frame has a large cavity intended to receive a main deposit 7 of a product that is to be dispensed, either by a controlled dropwise action directed at the corresponding channels or pipes, or by being sprayed directly into the atmosphere. In turn, on the lower base there is an outlet 8 for the channels for the dispensed liquid, which will normally be small pipes, supported by a pin or support 9 provided on the rear wall of the frame.

In its lower left hand part thereof, the frame has a cavity that is intended to receive a smaller deposit 10 that preferably contains an “essence” to be dispensed by means of a cord 11. This cord 11 is incorporated in the small deposit 10 by means of a plug 12 designed especially for this purpose, and by means of an air current generated by a fan 13, via said cord 11, the said essence will be dispensed into the atmosphere so as to fulfil the function of room freshener, deodorant or even insecticide, if necessary.

It is evident that, in the top left hand part thereof, the frame has a small fan 13 that is driven automatically and conveniently by a motor 14 to generate an air current, which, in contact with the cord 11 of the essence deposit 10, will correctly dispense the part of the essence needed to purify or disinfect the atmosphere.

In the top central left hand part there is a second motor 15, separate from the motor 14 coupled to the fan 13, its output including a gear 16 coupled to other transmission gears 17 in order to transmit a movement to a pusher element 18 which acts on a push-button 19 associated with a valve 20 in the large deposit 7 containing one of the products to be dispensed.

In the top right hand part, the dispenser comprises a vertical standing plate 21 with an electronic control circuit that incorporates a control program for the whole automated dispenser. The program allows the device to be programmed as required. In the top right hand part, the dispenser has a cavity 22 for housing the electrical batteries for both the control system plate 21 and the motors, that is, motor 15 connected to gears 17 of pusher element 18 of push-button 19 of the large deposit 7, and motor 14 of fan 13.

The front cover 5 of the dispenser is curved outwards 23, and in the top left hand part thereof it is provided with a grating 24 which acts as outlet for the essence dispensed by the air current generated by fan 13. In turn, a central grating 25 acts as air passage for the current generated by the fan 13, and as it is located at the same height as the cord 11 in the essence deposit 10, it can also perform the function of room freshener when the fan is not is use, and this is because it is provided, in turn, with a grating 26 in the lower part thereof, which causes an air current to be generated inside the apparatus, with or without the fan. It should be pointed out that the air inlets and outlets can be inverted as required, as well as the rotation direction given to the fan, since it will often depend on where the dispensing apparatus is installed.

It should be noted here that the push-button 19 can act as a sprayer. In this case, the cover 5 includes a small window 27 to let the dispensed product contained in the deposit 7 exit to the outside.

As can be seen, one single dispenser presents a series of characteristics whereby a series of functions can be combined, and it can dispense disinfectants, cleaning agents, deodorants, room fresheners and insecticides, combining their functions, by providing all its elements in a simple but compact manner, which is safe both in terms of its manufacturing and its final use, even when replacing the deposits. The said combination can be multiplied, since on many occasions several dispensers will be installed, for example, in public places, and therefore the function of each dispenser can be selected in combination with the function of the others, and this provides an even better array of multiple functions which is the result of the advantages of this invention, and which are not known to exist in the market in one single apparatus of this kind.

With reference to the numbering used in the invention specification and in the accompanying drawings, the multipurpose dispenser is seen to comprise a frame 1 to be supported on the wall in a conventional manner, there being provided for this purpose the holes 2 in both the top and bottom thereof, with even a hole in the top central part thereof, said frame having an outlet 8 in the lower part thereof for the pipes and a pin 9 also for said pipes in the event that the product is dispensed dropwise to said channels or pipes from the push-button 19.

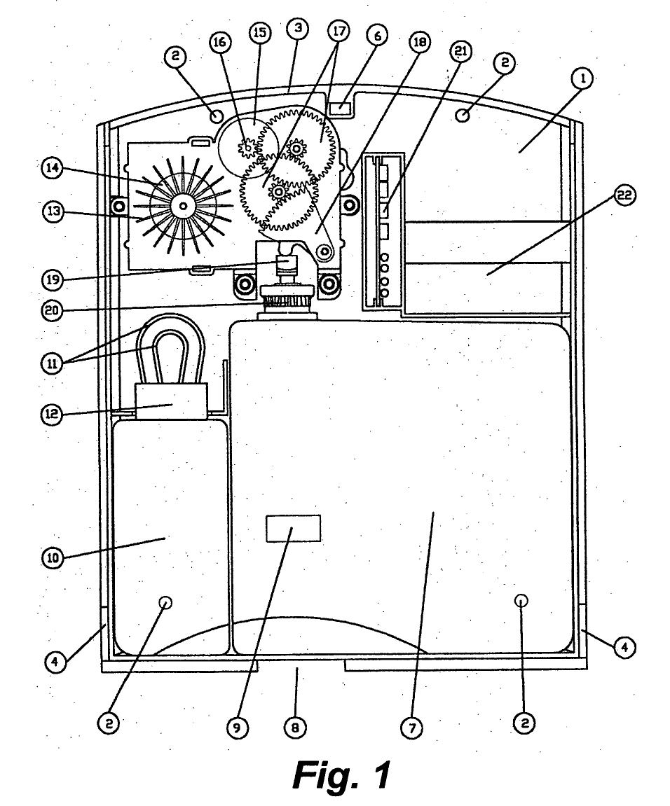

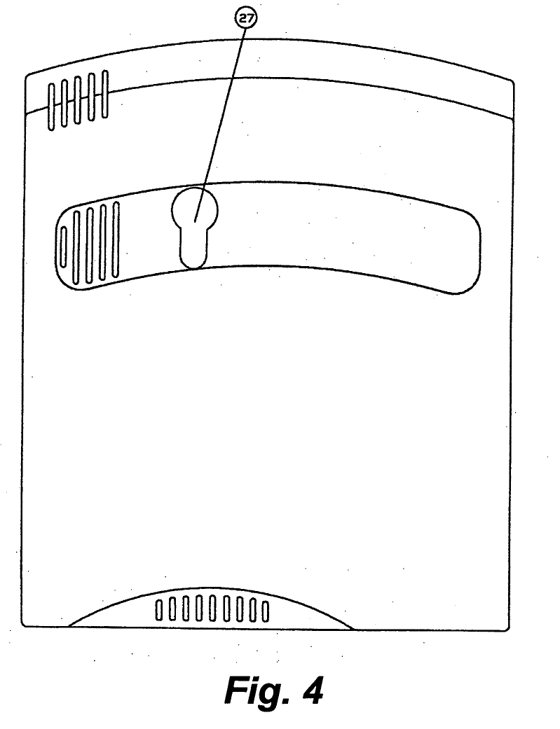

The larger size deposit 7 is arranged on the left hand central lower part of the frame, as illustrated in FIG. 1. In the top left hand part thereof, the larger size deposit 7 includes a corresponding valve 20 activated by the push-button 19, which acts by directing the drops towards the channels or pipes or, alternatively, by spraying them directly outwards through the window 27 in the cover 5 (illustrated in FIG. 4). The push-button 19 is activated by a pusher element 18, which is arranged in combination with gears 17 that receive the movement of a gear 16 connected to the output of a motor 15 powered by batteries housed at 22. The operation of the motor 15 is controlled by a control plate 21 on which all the dispenser functions are programmed, according to usage requirements.

The above arrangement is combined with that of the second deposit 10, located in the bottom left hand part. At the top thereof, the second deposit 10 comprises a cord 11 that evaporates the liquid contained in deposit 10. Above said cord there is a fan 13 that can generate an air current to dispense that evaporated by the cord 11. The fan 13 is driven by a motor 14 powered by the batteries housed at 22, and its operation is controlled according to that programmed on the control plate 21 whereby said plate controls both motors 14 and 15, combining the dispensing of each of the products contained in the deposits or containers 7 and 10, according to the requirements of each.

The whole dispenser mechanism described above is perfectly protected by a cover 5, which incorporates a safety lock 6 so that its handling is controlled by authorised personnel, when maintaining and replacing the deposits or containers 7 and 10 and the batteries 22 and even when programming the control plate 21. The function of the cover 5 is important, as can be seen, both in terms of manufacturing and use, and also because it provides the multipurpose dispenser with a unified and unique image.

1. A multipurpose dispenser, for use with batteries to dispense a product comprising:
a frame provided with wall support means and a front cover,
at least one deposit for a product to be dispensed,
at least one dispensing mechanism activated by driving means powered by said batteries, and
two deposits and for products to be dispensed, where one of said deposits incorporates a valve, which in the top part thereof has a push-button that is activated by a pusher element driven by the movement of a motor that is transmitted via gears and,
said motor being powered by said batteries located in a housing and controlled by a control plate, which in turn controls and combines the operation of said motor with that of another motor that drives a fan which circulates the air that is in contact with a product evaporated by a cord located in the other of said deposits, all this being combined in a simultaneous or alternative fashion, according to the control plate programming.

2. The multipurpose dispenser according to claim 1, wherein said cover comprises gratings in the top, central and bottom parts thereof, respectively, which cause the air current generated by the fan to circulate through them and the circulating air to come into contact with the product evaporated from the deposit by said cord.

3. The multipurpose dispenser according to claim 2, wherein said push-button is a sprayer push-button which dispenses the product contained in deposit directly into the outside atmosphere via a window included for this purpose in the front cover of the dispenser, in simultaneous or alternative combination with the dispensing of the product contained in the deposit by means of said gratings.

4. The multipurpose dispenser according to claim 2, wherein said push-button dispenses the product contained in the deposit into small pipes that are supported on the frame by a pin or support and traversed by an exit and directed towards the corresponding channels or pipes, to be treated in a dropwise manner, in simultaneous or alternative combination with the dispensing of the product contained in the deposit by means of said gratings.
